(19) United States
(12) Patent Application Publication
(10) Pub. No.: US 2002/0137219 A1
(43) Pub. Date: Sep. 26, 2002

(54) Titration method for aqueous base developer solution

(76) Inventors: Robert Austin Owens, Yardley, PA (US); Thomas Jacob, Carrollton, TX (US); Pilarcita Linda Ranque, Flemington, NJ (US); Lizhong Zhang, Plainfield, NJ (US)

Correspondence Address: Krishna G. Banerjee, 70 Meister Avenue, Somerville, NJ, 08876, US

(21) Appl. No.: 09/765,540

(22) Filed: Jan. 19, 2001

(51) Int. Cl. G01N 35/00; G01N 31/16; G01N 31/22; G03C 5/30; G03C 5/00

(52) U.S. Cl. 436/51; 436/79; 436/106; 436/163; 430/331; 430/485

(57) ABSTRACT

Disclosed is a titration method for determining the concentration of a base developer solution to within ±0.02 mN, which involves performing steps (a) and (b) in any order: (a) weighing to ±0.001%, an amount of a solution of aqueous base developer of known approximate normality; (b) weighing to ±0.001%, an amount of an acid titrant sufficient to neutralize at least 90% of the base developer in the solution of step (a); thereafter performing steps (c)-(e) in the following order: (c) contacting the aqueous base developer solution with the acid titrant to neutralize at least 90% of the base developer in the solution, and leaving from about 1% to about 10% of the original aqueous base developer as residual non-neutralized base developer in the solution; (d) titrating the residual non-neutralized base developer in the solution with the acid titrant to the end point in an inert atmosphere, wherein the temperature of the titrant is maintained at a temperature of about 20-30° C.±0.2° C., the normality of the acid titrant is known to within ±0.01 mN; and wherein the vessel dispensing the titrant contains sufficient titrant to titrate the residual non-neutralized base. developer in the solution to the end point, without having to be refilled, and wherein the volume of titrant dispensed for the titration is at least 70% of the vessel volume; and (e) calculating the normality of the aqueous base developer solution to within ±0.02 mN; wherein the density of the aqueous base developer solution and the titrant are known to ±0.00001 g/ml, and steps (a)-(c) are carried out under conditions sufficient to minimize base developer and titrant evaporation and uptake of carbon dioxide from the atmosphere.

### BACKGROUND OF THE INVENTION

The functional performance of aqueous base developers used with positive photoresist compositions is directly dependent upon the base concentration. The photospeed of a photoresist composition changes approximately 1% per 1 millinormal (mN) change in total normality. Therefore controlling the normality of the developer is important for achieving consistent photoresist performance.

The normality (base content) of developer solutions can be determined by titration. Standard titration techniques using autotitrators give test-retest error of about 0.1 mN. With such, one can expect to control the normality of a developer to ±0.5 mN.

In order to satisfy semiconductor manufacturers'need to control processes tighter, the normality of developer solutions needs to be controlled to <0.1 mN. The present invention fulfills such a need. It provides an improved titration method to measure and, consequently, control the concentration of aqueous base developer solutions.

### SUMMARY OF THE INVENTION

The present invention provides a titration method for determining the concentration of a base developer solution to within ±0.02 mN, said method comprising:

performing steps (a) and (b) in any order:

(a) weighing to ±0.001%, an amount of a solution of aqueous base developer of known approximate normality;

(b) weighing to ±0.001%, an amount of an acid titrant sufficient to neutralize at least 90% of the aqueous base developer in the solution of step (a);

thereafter performing steps (c)-(e) in the following order:

(c) contacting the aqueous base developer solution with the acid titrant to neutralize at least 90% of the aqueous base developer in the solution, and leaving from about 1% to about 10% of the original aqueous base developer as residual non-neutralized base developer in the solution;

(d) titrating the residual non-neutralized base developer in the solution with the acid titrant to the end point in an inert atmosphere;

wherein the temperature of the acid titrant is maintained at a temperature of about 20-30° C.±0.2° C., the normality of the acid titrant is known to within ±0.01 mN; and wherein the vessel dispensing the titrant contains sufficient titrant to titrate the residual non-neutralized base developer solution to the end point, without having to be refilled, and wherein the volume of titrant dispensed for the titration is at least 70% of the vessel volume; and

(e) calculating the normality of the aqueous base developer solution to within ±0.02 mN;

wherein the densities of the aqueous base developer solution and the acid titrant are known to ±0.00001 g/ml, and steps (a)-(c) are carried out under conditions sufficient to minimize base developer and titrant evaporation, and uptake of carbon dioxide from the atmosphere.

### BRIEF DESCRIPTION OF THE DRAWINGS

FIG. 1 is a titration curve (pH vs. volume of acid titrant added) generated by a Metrohm™716 DMS Titrino™ Autotitrator in the titration method of the present invention.

### DETAILED DESCRIPTION OF THE INVENTION

The present invention provides a titration method for determining the concentration of a base developer solution to within ±0.02 mN. The method involves perfoming the steps (a) and (b) in any order. Step (a) of the method involves weighing to 0.001%, an amount of a solution of aqueous base of known approximate normality.

The base can be any water-soluble base suitable for use in a developer solution for photoresist compositions. Examples include without limitation, sodium hydroxide, potassium hydroxide, N-tetramethylammonium hydroxide, N-tetraethylammonium hydroxide, N-tetrabutylammonium hydroxide, and sodium silicate.

To determine the normality of the base developer solution to the highest precision, the volume and weight of the developer solution should ideally be as large as possible. However, there are limits to the capacity of the weighing equipment and the volume of titrant that can be dispensed. Thus a volume and weight of developer solution should be used based upon a combination of the precision of the analytical scale used for weighing, the known approximate normality of the base solution, the normality of the acid titrant and the volume capacity of the vessel dispensing the titrant.

In one embodiment, the weight of the developer solution ranges from 10 grams to 500 grams, and in one embodiment, from 90 to 150 grams.

In one embodiment, the normality of the aqueous base developer solution ranges from 0.1 N to 1.0 N, and in one embodiment, 0.2 to 0.6 N.

Step (b) of the present method involves weighing to ±0.001%, an amount of an acid sufficient to neutralize at least 90% of the base developer in the solution.

The acid titrant is typically a mineral acid, such as hydrochoric, sulfuric or nitric acid.

In one embodiment, step (a) is performed first, followed by step (b), and in one embodiment step (b) is performed first, followed by step (a). The preferred method is the performance of step (b), followed by step (a), as set forth in the examples below.

The third step (c) of the present method involves contacting the aqueous base developer solution with the acid titrant to neutralize at least 90% of the base developer in the solution, and leaving 1% to 10% of the original aqueous base developer as residual non-neutralized base developer in the solution.

The fourth step (d) of the present method involves titrating the residual non-neutralized base developer in the solution with the acid titrant to the end point in an inert atmosphere, wherein the temperature of the titrant is maintained at 20-30° C.±0.2° C., and in one embodiment 25° C.±0.2° C., the normality of the acid titrant is known to within ±0.01 mN; and wherein the vessel dispensing the titrant contains sufficient titrant to titrate the non-neutralized base developer in the solution without having to be refilled during the titration, and wherein the volume of titrant dispensed during the titration is at least 70% of the vessel volume.

As used herein, the phrase “end point” encompasses the standard definition known to one of ordinary skill in the art of titration techniques. The end point may sometimes be referred to as the “equivalence point”. The end point of the titration, a neutralization reaction, is characterized by a sudden change in negative log of the hydrogen ion concentration (pH) in the plot of pH vs. volume of titrant. Any method, including, but not limited to potentiometry, colorimetry, voltametry, amperometry, and polarography, that detects this change may be used. Electronic determinations may be facilitated by the use of automatic titrators with data acquisition and processing capability.

The temperature of a laboratory can change substantially during a day, and day-to-day causing errors in normality. Therefore, the temperature of the titrant is controlled to ±0.2° C., such as by placing it in a constant temperature bath. By way of example, the density of a 0.2500 N titrant was measured at various temperatures using a 5-decimal place density meter. The density of the titrant was found to change by 0.000274 g/ml/° C. that resulted in a normality change of 0.068 mN/° C. of the titrant and approximately a 0.012 mN/°C. error in the sample test result. Therefore, it is important to control the temperature of the titrant to ±0.2° C., such as 25° C.±0.2° C., such as by placing the titrant in a constant temperature bath.

In one embodiment, the vessel dispensing the titrant is a buret, such as one having a volume capacity of 100 ml, and in one embodiment 5, 10, 20, and 50 ml. By way of example, the buret dispensing the titrant is flushed with fresh titrant, before beginning a series of titrations in order to minimize the thermal effects of the environment on the buret volume.

In one embodiment, the titration is carried out by a computer controlled, automatic titrator, such as those manufactured under the names Metrohm™, Brinkman™ and Schott™. In one embodiment, the automatic titrator is a Metrohm™716 DMS Titrino™ Autotitrator, using a Brinkman™ Work Cell™ version 3.1 software equipped with a Metrohm™ Dosimate™ unit with a 20-ml buret, a Metrohm™ combination pH glass electrode, and a Metrohm™ Metrosensor temperature probe. Another example of an automatic titrator suitable for use in the present invention is a Schott™ Titroline™ Alpha autotitrator with Schott's Blueline pH electrode.

Typically the autotitrators employ burettes having a plunger to dispense the titrant. The plunger has a stroke length that varies depending on the length of the buret. Refilling the buret introduces measurement error, thus it is best that the titrator does not have to refill the buret during the titration. Furthermore, utilising at least 70% of the buret plunger stroke length is used to deliver the titrant. Utilizing at least 70% of the buret stroke gives a greater number of aliquots of titrant delivered and reduces measurement error. In one embodiment, the acid titrant is dispensed in minimum aliquot volumes of 1 to 20 microliters (μl), and in one embodiment 5 μl and in one embodiment 2 μl.

For example, in one embodiment, a 20-ml buret is used. The autotitrator divides its full stroke into 10,000 increments, to give a volume of 20 ml/10,000 increments, or 2 μl/increment, i.e., fine resolution. With a 0.25 N HCI titrant, the minimum number of equivalents per increment is (0.25 N×2×10⁻³ml) or 0.0005 milliequivalents (meq).

Steps (a)-(c) of the present invention are carried out under conditions sufficient to minimize base developer and titrant evaporation and uptake of carbon dioxide from the atmosphere.

Aqueous base solutions easily absorb carbon dioxide (CO₂) from the air. The CO₂ from the air forms carbonic acid upon reacting with water. The carbonic acid can neutralize the base (see equations below):

$$C {O}_{2} ( g ) + {H}_{2} O {\to }_{{H}_{2} O} {H}_{2} C {O}_{3} ( a q u e o u s )$$

$${H}_{2} C {O}_{3} ( a q u e o u s ) + {2 [ O H ]}^{-} ( a q u e o u s ) {\to }_{{H}_{2} O} {[ C {O}_{3} ]}^{=} ( a q u e o u s ) + {H}_{2} O$$

As a base developer solution is titrated, it is stirred vigorously, so carbon dioxide uptake is accelerated. In air, the rate of carbon dioxide uptake is about 1 ppm per minute. The pH of the solution is basic (typically >9) even after the initial contacting of the sample and the acid (in step (c)), so carbon dioxide can be absorbed from air and converted to carbonate, effectively neutralizing the solution and changing the measured result. Thus, absent the steps taken to minimize/avoid carbon dioxide uptake, one would expect interference and error to be present in the titration (step (d)) which could take several minutes to complete.

Furthermore, the base developer (which includes a solvent comprising water that is used to make the base developer solution) and the titrant (which includes a solvent comprising water that is used to prepare the acid titrant solution) can also evaporate causing weighing errors to impact the measured result. To minimize the errors from such evaporation, it is important to perform all weighing operations (including the weighing of the aqueous base developer solution in step (a) and the weighing of the acid titrant in step (b)) in closed containers such as bottles.

The titration is also performed under inert conditions, such as under nitrogen or argon atmosphere (e.g., dry box) to minimize/avoid uptake of carbon dioxide during the titration.

The densities of the base sample and the acid titrant are measured to ±0.00001 g/ml. A Mettler™ Density Meter model DE-51 densitometer can be used for performing such density measurements. By way of example, the weighing of the acid titrant and the aqueous base developer solution to ±0.001% can be performed by a Mettler™ AT201 analytical balance.

The final step (e) of the present method is to calculate the normality of the aqeuous base developer solution to within ±0.02 mN, based on the values obtained from steps (a)-(c), and wherein the density of the aqueous base developer solution is known to ±0.00001 g/ml.

If N₁ is the normality of the acid titrant, V₁ is the total volume of the titrant, V_{T} is the volume of the titrant added gravimetrically, V_{T}′ is the volume of the titrant added volumetrically from the titration, N₂ is the normality of the developer solution, D_{T} is the density of the titrant, D_{S} is the density of the developer solution, W_{T} is the weight of the titrant added gravimetrically, and W_{S} is the weight of the developer solution, then:

V_{T}=W_{T}/D_{T} (equation 1);

V₁=V_{T}+V_{T′} (equation 2);

V₁=(W_{T}/D_{T})+V_{T′} (equation 3);

and

V_{2=W}_{S}/D_{S} (equation 4).

From the equation

N₁V₁=N₂V₂ (equation 5),

and solving for N₂ yields

$$\begin{matrix}{N}_{2} = \frac{{N}_{1} {V}_{1}}{{V}_{2}} = \frac{{N}_{1} ( \frac{{W}_{T}}{{D}_{T}} + {V}_{T}^{′} )}{\frac{{W}_{S}}{{D}_{S}}} & ( equation 6 ) \\ {N}_{2} = \frac{{N}_{1} {D}_{S} ( \frac{{W}_{T}}{{D}_{T}} + {V}_{T}^{′} )}{{W}_{S}} & ( e q u a t i o n 7 )\end{matrix}$$

Equation 7 is the basic general equation for calculating the normality of the aqueous base developer solution.

### EXAMPLES

The following specific examples will provide detailed illustrations of the present invention. These examples are not intended, however, to limit or restrict the scope of the invention in any way and should not be construed as providing conditions, parameters or values which must be utilized exclusively in order to practice the present invention. Unless otherwise specified, all parts and percents are by weight, and all temperatures are in degrees Centigrade.

### Example 1

The following protocol is an illustration of the detailed procedural steps of the present invention.

1. Determine the titrant density.

1.1. Calibrate the 5-place density meter.

1.2. Measure and record the density of the titrant (Dₗ).

2. Determine developer solution Density

2.1. Calibrate the 5-place density meter.

2.2. Measure and record the density of the base developer solution (S_{T}).

3. Titrant Preparation

3.1. Tare the 250-ml Teflon® (PTFE, polytetrafluoroethylene) titration bottle with cap.

3.2. Add 90 ml of titrant from the external titrant-dispensing unit.

3.3. Cap the titration bottle immediately to avoid evaporation.

3.4. Record the weight of titrant (W_{T}).

3.5. Place the titration bottle in the nitrogen atmosphere titration chamber and carefully add the stir bar without splashing.

4. Preparation of developer solution

4.1. Add base developer solution to the 100-ml Teflon® sample bottle up to the 100 ml sample mark.

4.2. Cap the sample bottle immediately to avoid evaporation and CO₂ uptake.

4.3. Zero the balance and weigh the sample bottle and developer solution.

4.4. Place the sample bottle in the titration chamber.

4.5. Open the sample bottle and carefully pour the developer solution into the titration bottle.

4.6. Recap the empty sample bottle.

4.7. Remove the sample bottle from the titration chamber.

4.8. Reweigh the empty sample bottle and record the weight of developer solution (W_{S}).

5. Titration

5.1. Place the titration bottle on the stirrer plate and start the titration.

5.2. When the titration is finished, print the results report.

5.3. Record the volume of titrant used to reach the end-point (V_{T}).

6. Calculate the normality of the developer solution by using equation 7.

The Examples below set forth values for the various parameters from different titration experiments used to calculate the normality of the aqueous base developer solution from equation 7.

| | |
|---|---|
| N₁ (normality of the acid titrant) | 0.25045 N |
| D_{T} (density of the titrant) | 1.00157 g/ml |
| D_{S} (density of the developer solution) | 0.99849 g/ml |
| W_{S} (weight of the developer solution) | 101.3092 g |
| W_{T} (weight of titrant added gravimetrically) | 90.6786 g |
| V_{T}′ (volume of titrant added volumetrically) | 15.200 ml |
| Approximate total volume of base developer | 207 ml |
| solution and titrant | |
| N₂ (normality of the base developer solution) | 0.26100 N |

The normality of the sample, N₂ is calculated using equation 7:

$${N}_{2} = \frac{{N}_{1} {D}_{S} ( \frac{{W}_{T}}{{D}_{T}} + {V}_{T}^{′} )}{{W}_{S}}$$

$${N}_{2} = \frac{( 0.25045 N ) ( 0.99849 \text{g/ml} ) ( \frac{90.6785 g}{1.00157 \text{g/ml}} + 15.200 ml )}{101.3093 g}$$

$${N}_{2} = 0.26100 N$$

### Example 3

| | |
|---|---|
| N₁ (normality of the acid titrant) | 0.25045 N |
| D_{T} (density of the titrant) | 1.00157 g/ml |
| D_{S} (density of the developer solution) | 0.99849 g/ml |
| W_{S} (weight of the developer solution) | 103.4873 g |
| W_{T} (weight of titrant added gravimetrically) | 89.6256 g |
| V_{T}′ (volume of titrant added volumetrically) | 18.537 ml |
| Approximate total volume of base developer | 212 ml |
| solution and titrant | |
| N₂ (normality of the developer solution) | 0.26103 N |

### Example 4

| | |
|---|---|
| N₁ (normality of the acid titrant) | 0.25045 N |
| D_{T} (density of the titrant) | 1.00157 g/ml |
| D_{S} (density of the developer solution) | 0.99849 g/ml |
| W_{S} (weight of the developer solution) | 105.6750 g |
| W_{T} (weight of titrant added gravimetrically) | 93.1517 g |
| V_{T}′ (volume of titrant added volumetrically) | 17.300 ml |
| Approximate total volume of base developer | 216 ml |
| solution and titrant | |
| N₂ (normality of the developer solution) | 0.26103 N |

### Example 5

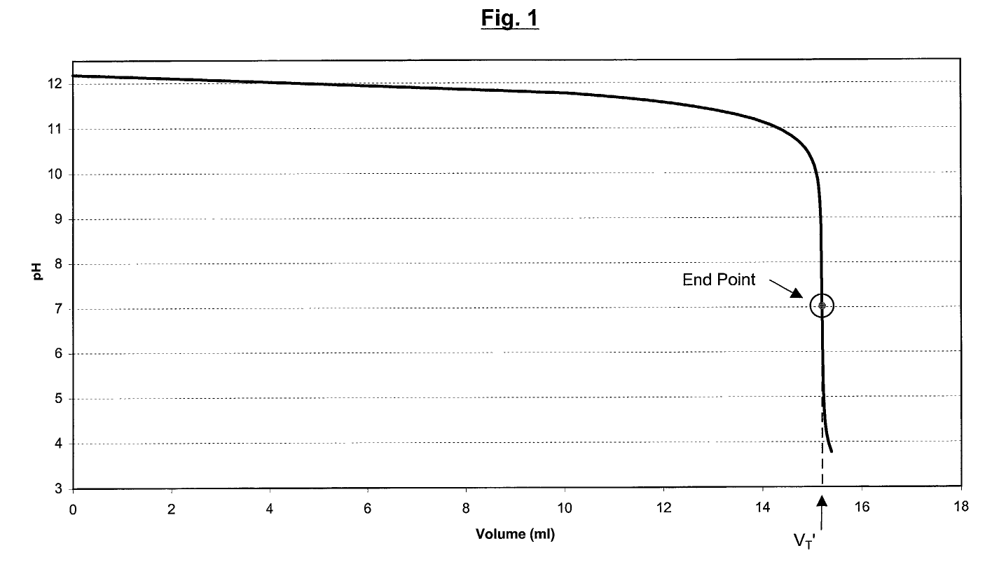

FIG. 1 is a titration curve (pH vs. volume of acid titrant added) generated by a Metrohm™ 716 DMS Titrino™ Autotitrator in the titration method of the present invention. The curve represents the titration of Example 2 above. The volume shown at the end point is actually the volume of the titrant added volumetrically (V_{T}=′15.200 ml) after the initial gravimetric addition of the titrant. The end point appears at pH 7.0.

Except in the Examples, or where otherwise explicitly indicated, all numerical quantities in this description specifying amounts of materials, reaction and process conditions (such as temperature, time, pressure), and the like are to be understood to be modified by the word “about”.

WHAT IS CLAIMED IS:

1. A titration method for determining the concentration of a base developer solution to within ±0.02 mN, said method comprising:
performing steps (a) and (b) in any order:
(a) weighing to ±0.001%, an amount of a solution of aqueous base developer of known approximate normality;
(b) weighing to ±0.001%, an amount of an acid titrant sufficient to neutralize at least 90% of the base developer in the solution of step (a);
thereafter performing steps (c)-(e) in the following order:
(c) contacting the aqueous base developer solution with the acid titrant to neutralize at least 90% of the base developer in the solution, and leaving from about 1% to about 10% of the original aqueous base developer as residual non-neutralized base developer in the solution;
(d) titrating the residual non-neutralized base developer in the solution with the acid titrant to the end point in an inert atmosphere;
wherein the temperature of the acid titrant is maintained at a temperature of about 20-30° C.±0.2° C., the normality of the acid titrant is known to within ±0.01 mN; and wherein the vessel dispensing the titrant contains sufficient titrant to titrate the residual non-neutralized base developer in the solution to the end point, without having to be refilled, and wherein the volume of titrant dispensed for the titration is at least 70% of the vessel volume; and
(e) calculating the normality of the aqueous base developer solution to within ±0.02 mN;
wherein the densities of the aqueous base developer solution and the acid titrant are known to ±0.00001 g/ml, and steps (a)-(c) are carried out under conditions sufficient to minimize base developer and titrant evaporation, and uptake of carbon dioxide from the atmosphere.

2. The method of claim 1, wherein step (a) is performed after step (b).

3. The method of claim 1, wherein step (b) is performed after step (a).

4. The method of claim 1, wherein in step (a), the aqueous base developer is a member selected from the group consisting of N-tetramethylammonium hydroxide, N-tetraethylammonium hydroxide, N-tetrabutylammonium hydroxide, sodium hydroxide, potassium hydroxide and sodium silicate.

5. The method of claim 1, wherein the conditions sufficient to minimize uptake of carbon dioxide from the atmosphere comprise inert atmosphere.

6. The method of claim 3, wherein inert atmosphere is a nitrogen or argon atmosphere.

7. The method of claim 1, wherein carrying out steps (a)-(d) under conditions sufficient to minimize base developer and titrant evaporation comprise weighing the aqueous base solution in step (a) and the acid titrant in step (b) using closed containers.

8. The method of claim 1, wherein in step (a), the known approximate normality of the aqueous base developer solution is within about 90 to 99% of the normality of the acid titrant.

9. The method of claim 1, wherein the acid titrant is a mineral acid.

10. The method of claim 7, wherein the mineral acid is a member selected from the group consisting of hydrochloric acid, sulfuric acid and nitric acid.

11. The method of claim 1, wherein in step (c), the vessel is a buret.

12. The method of claim 11, wherein the buret has a volume capacity of about 10 ml to about 100 ml.

13. The method of claim 11, wherein the buret comprises a buret having a plunger.

14. The method of claim 13, wherein the buret having a plunger has a plunger stroke length that is about 75% of buret length.

15. The method of claim 1, wherein in step (c), the titration is carried out by a computer controlled, automatic titrator.

16. The method of claim 1, wherein in step (c), the approximate normality of the aqueous base developer solution ranges from about 0.1 N to about 1.0 N.

17. The method of claim 1, wherein in step (c), the acid titrant is dispensed in minimum aliquot volumes of about 1 μl to about 20 μl.

18. The method of claim 1, wherein in step (c), the temperature of the titrant is maintained at 25° C.±0.2° C.
